(19) United States
(12) Patent Application Publication
(10) Pub. No.: US 2007/0280484 A1
(43) Pub. Date: Dec. 6, 2007

(54) Vsr surround sound tube headphone

(76) Inventor: Yul Lavauno Anderson, Vallejo, CA (US)

Correspondence Address: Yul Lavauno Anderson, 1003 Vervais Avenue, Vallejo, CA, 94591, US

(21) Appl. No.: 10/592,576

(22) PCT Filed: Jan. 14, 2004
(86) PCT No.: PCT/EP03/13491

§ 371 Date: Sep. 13, 2006

(30) Foreign Application Priority Data
Nov. 27, 2003 (DK) PA 2003 01776

(51) Int. Cl. H04R 5/033

(52) U.S. Cl. 381/17; 381/376

(57) ABSTRACT

The VSR Surround Tube Headphone “The Crown” creates authentic surround sound without use of echo, reverb or other artificially induced “digital magic” effects. It allows the surround sound to come from all directions through 5-6-7 speakers with different levels and sound frequencies circulating within the diameter of the tube and located within and without the tube each with their own individual volume levels and 2 audio openings (1 on each side) for audio output to each ear of the listener. The “crown like” surround sound device fits upon the head much like that of a “crown”. It gives you the only true surround sound experience 360 degrees. It can claim 5-7 different channel audio reception from 5-7 speakers all within or without a tube device containing the levels of true surround sound from all around you into your ears.

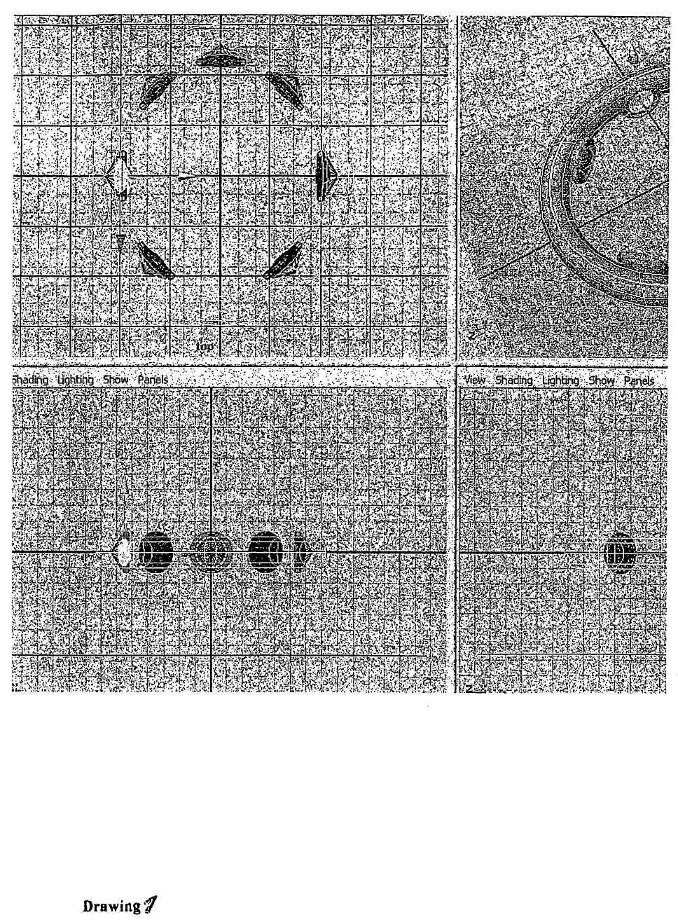

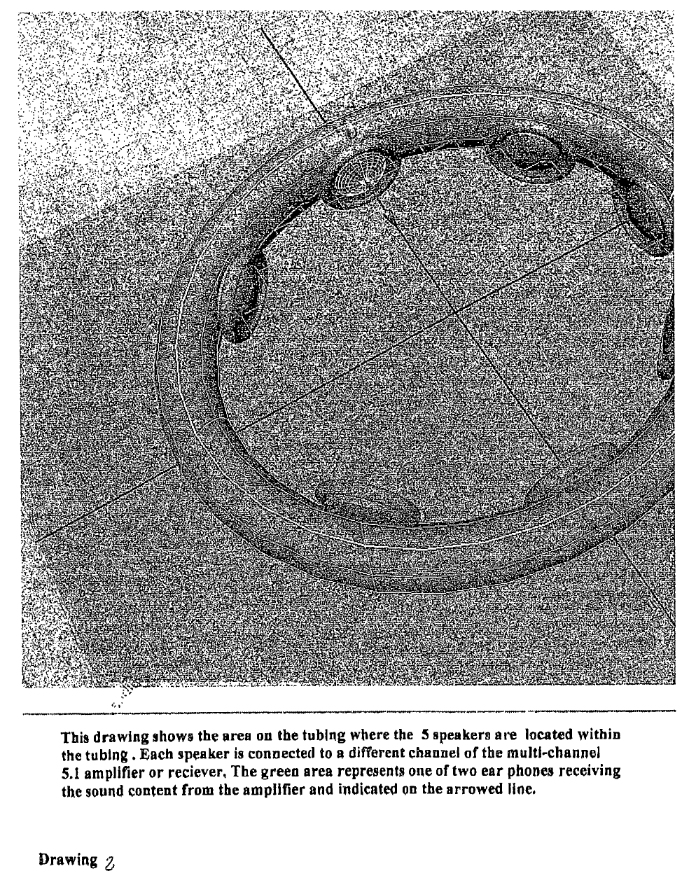

### DESCRIPTION

1. Method and tubular headphone is a apparatus for hearing multi-channel audio content through 3, 4, 5, 6, or 7 or more speakers located within or without a tube which fits around the head with 2 openings for audio reception in the left and right ear receiving sound input from the tube acoustics' audio production output from infrared, wireless, audio signal or wire connection to digital, analog or any audio production process i.e. receiver, amplifiers, or any device producing sound frequency.

2. The tube like headphone apparatus fits around the head with 3 to 7 or more speakers separately connecting to a multi-channel audio output.

3. The Surround Sound Tube Headphone System has 2 or more multi-channel speakers within a tube which fits around the head with 2 opening for the left and right ear audio reception

4. The tubular audio reception device can be worn around the head and contains 2 or more speakers within or without the diameter of the tube.

5. The Surround Sound Tube Headphone System audio reception acoustics' quality can vary depending on the kind of tubing material used i.e. wood, plastic, rubber, cardboard etc.

6. The audio reception can be received through different size tubing connecting to directly from the speakers within separate tubing sections in front and rear of the head to the left and right ear (see sample drawing below)

7. The headphone can also have a built-in 5.1 converter which allow normal 2.0 output to be converted into 5.1 when using the VSR Surround Sound Tube Headphone. This is done by use of Mp2 and AC3 decoder broadcast system. Thus, the 5.1 VSR Surround Sound Tube Headphones could also convert the 2.0 signal into a 5.1 signal. This is one technical specification of the more advance Surround Sound Tube Headphone System models.

8. The VSR Surround Sound Tube Headphone is the first portable 5.1 audio device ever invented. In essence, it enables the consumer to transport 5.1 Home Theatre experience anywhere and everywhere opening the floodgates to high quality portable audio/visual consumer electronical devices not yet existing including a 5.1 portable DVD/Receiver.

1. As the material of the Surround Sound Tube Headphone System changes with technological advancement of new “sound perspectives” a “real life” sound output and content is found with acoustics reflecting environmental material which is reflected in the tubing material. The acoustical environment and sound content of the Surround Sound Tube Headphone System are therefore genuine Microcosms or miniature versions of the 5.1 6.1 7.1 or more speaker set-up found in the living room, studios, or rooms capturing authentic, real life and concerted sound experiences recorded in 5.1, 6.1, 7.1 or more multi-channel and used by those who have a standard 5.1 DTS or 5.1 Dolby Surround Sound amplifier

2. Method and tubular headphone apparatus for hearing multi-channel audio content through 3, 4, 5, 6, or 7 or more speakers located within or without a tube which fits around the head with 2 openings for audio reception in the left and right ear receiving sound input from the tube acoustics' audio production output from infrared, wireless, audio signal or wire connection to digital, analog or any audio production process i.e. receiver, amplifiers, or any device producing sound frequency.

3. A ear apparatus in which conduction by sounds takes place through a vacuum or a audio content medium within a sealed tube and which has various uses based on the controlled flow of sounds.

4. The VSR Surround Sound Tube Headphone “5-6-7 speakers are separately connected to each speaker channel input of the 5.1, 6.1 or 7.1 receiver or amplifier. These channels coincide with the speakers placement within or without the diameter of the tube. For example, located on the forehead of the tube is the CS (center speaker), to the left of the forehead is the FLS (front left speaker) to the right of the forehead is the FRS (front right speaker), in the back left side of the tube is the BLS (back left speaker) in the back right side of the tube is the BRS (back right speaker) the sub-bass miniature speaker is located in the front under the CS.

5. An acoustical sounds tube in which audio content passes through 3, 4, 5, 6, 7 or more speakers producing surround sound duplicating 5.1, 6.1, 7.1 speaker set-up in a living room, studio or movie theatre.

6. A tube like headphone apparatus that fits around the head with 3 to 7 or more speakers separately connecting to a multi-channel audio output.

7. Authentic 2 or more multi-channel speakers within a tube which fits around the head with 2 opening for the left and right ear audio reception

8. A tubular audio reception device worn around the head containing 2 or more speakers within or without the diameter of the tube—usually used in plural.

9. The Surround Sound Tube Headphone System apparatus function can carry audio content and create authentic 5.1, 6.1, 7.1 audio reception from speakers output from 3, 4, 5, 6, or 7 or more speakers located within or without the diameter of a tube fitting around the head or in separate parts located in front, side and back of the head and connected to audio reception tubing connecting to and bringing audio content to the left and right ear of the listener. The audio content quality can be changed or varied depending on the size, shape and material used.

10. The Surround Sound Tube Headphone System apparatus can carry audio content carried through tubing connected to tubing containing 3, 4, 5, 6, 7, or more multi-channel speakers bringing audio content to the right and left hear located around and about the head.

11. Location of the multi-channel speakers in the tubing can create authentic surround sound audio content reception equal to, similar to, or reflecting that of 5.1, 6.1, 7.1 speaker set-up in a room (see illustration below).

12. The Surround Sound Tube Headphone System is the only headphone apparatus invented that claims the above clause 10 and 11.

13. The Surround Sound Tube Headphone System is the only headphone known and that can claim to be authentic surround sound audio reception carrying 5.1, 6.1, 7.1 or more audio content similar to a 5.1, 6.1, 7.1 speakers set-up in a room. Therefore, is the most authentic and true sounding headphone system to the home multi-channel speaker set-up in a room.

14. The Surround Sound Tube Headphone System is the type of headphone that has 3, 4, 5, 6, 7 or more real speakers located within or without the diameter of a tube carrying audio content from a 5.1, 6.1, 7.1 or more receiver, amplifier, or any other audio output and can be used for exception sound quality with normal stereo output also.

15. No other Surround Sound Headphone System can claim 4.1 5.1, 6.1, 7.1 or more audio output from a multi-channel of 3, 4, 5, 6, 7 or more speakers located within a tube which brings authentic surround sound reception to the ears similar to and no different than that of a surround sound speaker system set-up in a room, studio, or sound environment.

16. Each speaker within or without the diameter of the tubing is connected to separate wires that connect to there related multi-channels (front right, front left, center, back right and back left, and addition sub-woofer) of the 5.1 amplifier or receiver speaker output

17. Any method using a tubing apparatus that goes around the head with 3, 4, 5, 6, 7, or more speakers connected by wire, infrared, or by wireless or any other sound transmitting technology that receives multi-channel 5.1, 6.1, 7.1 surround sound audio content or signals from a 5.1 amplifier or receiver.
